(19) United States
(12) Patent Application Publication
(10) Pub. No.: US 2015/0123553 A1
(43) Pub. Date: May 7, 2015

(54) MULTI-CONTROL LIGHT REGULATOR

(71) Applicant: PHILIO TECHNOLOGY CORPORATION, New Taipei City (TW)

(72) Inventor: Cheng-Hung HUANG, NEW TAIPEI CITY (TW)

(73) Assignee: PHILIO TECHNOLOGY CORPORATION, New Taipei City (TW)

(21) Appl. No.: 14/069,898

(22) Filed: Nov. 1, 2013

(51) Int. Cl. H05B 33/08

(52) U.S. Cl. CPC H05B 33/0815; H05B 33/0851
USPC 315/200 R

(57) ABSTRACT

A multi-control light regulator includes a microprocessor, a regulator including a rectifier electrically connected to a power source and a LED lamp and a drive circuit electrically connected to the rectifier and the microprocessor, and a sensor electrically connected to the microprocessor and the power source. Thus, the microprocessor determines the LED lamp to be dimmable or non-dimmable subject to the operation of the regulator and gives a proper control to the LED lamp.

### BACKGROUND OF THE INVENTION

1. Field of the Invention

The present invention relates to light regulation technology, and more particularly, to a multi-control light regulator for regulating the luminosity of a LED lamp.

2. Description of the Related Art

Since the resistance of an incandescent bulb allows pass of electric current to produce a flickering effect when the voltage is very low, regular light regulators commonly use a variable resistor for regulating the luminosity of the bulb. Regular LED lamps include dimmable type and non-dimmable type subject to the type of the drive circuit used therein. If a user installs a non-dimmable LED lamp to a dimmable lighting fixture, the lifespan of the lighting fixture will be shortened, and accidents can happen.

### SUMMARY OF THE INVENTION

The present invention has been accomplished under the circumstances in view. It is the main object of the present invention to provide a multi-control light regulator, which determines the LED lamp to be dimmable or non-dimmable before regulating the luminosity, and then gives a proper control to the LED lamp after determined the type of the LED lamp, avoiding unnecessary problems.

To achieve this and other objects of the present invention, a multi-control light regulator of the invention comprises a microprocessor, a regulator and a sensor. The regulator comprises a rectifier and a drive circuit. The drive circuit is electrically connected with the rectifier. The rectifier is electrically connected to a power source and a LED lamp. The drive circuit is electrically connected to the microprocessor. The sensor is electrically connected to the microprocessor and the power source.

### BRIEF DESCRIPTION OF THE DRAWINGS

FIG. 1 is a circuit block diagram of a multi-control light regulator in accordance with a first embodiment of the present invention.

FIG. 2 is a circuit diagram of the multi-control light regulator in accordance with the first embodiment of the present invention.

FIG. 3 is a circuit block diagram of a multi-control light regulator in accordance with a second embodiment of the present invention.

FIG. 4 is a circuit diagram of the multi-control light regulator in accordance with the second embodiment of the present invention.

### DETAILED DESCRIPTION OF THE PREFERRED EMBODIMENT

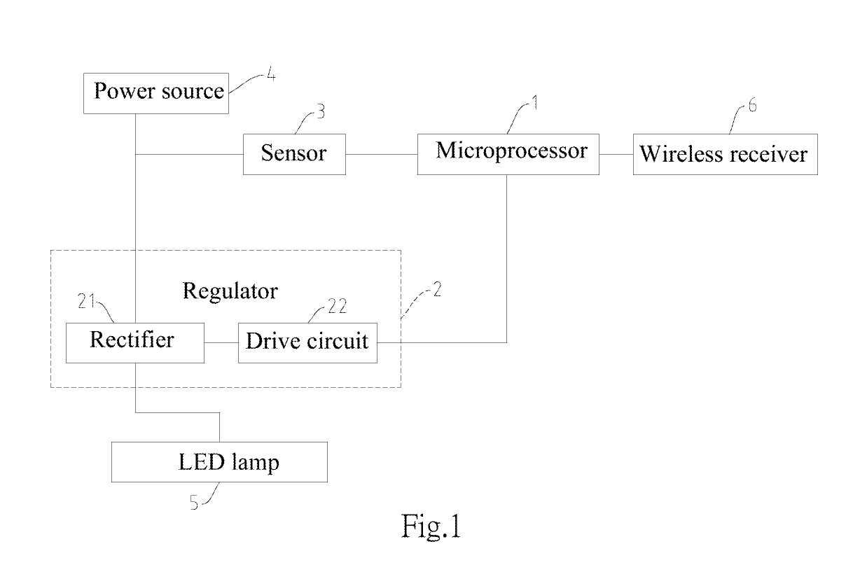

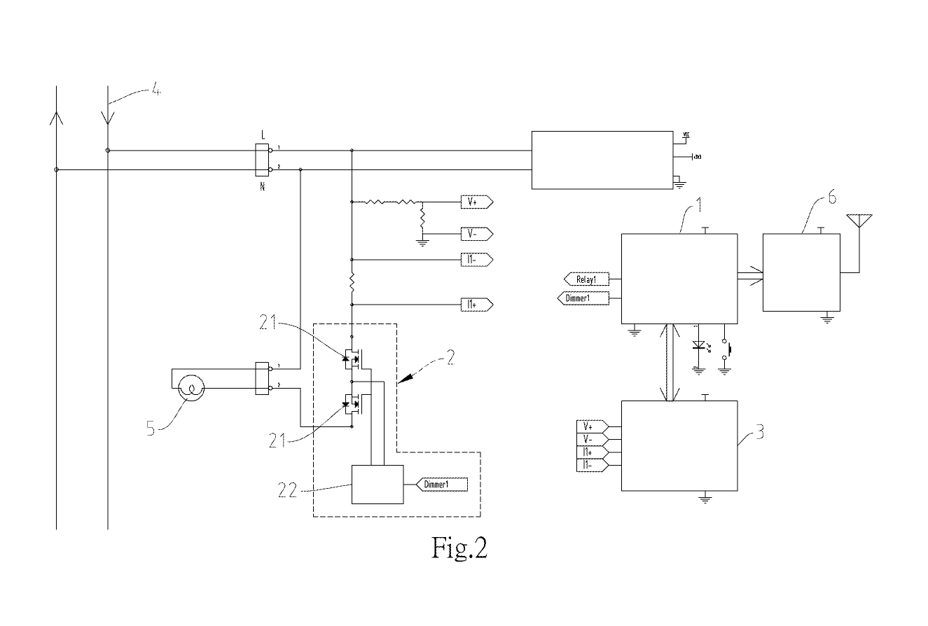

Referring to FIGS. 1 and 2, a multi-control light regulator in accordance with a first embodiment of the present invention is shown. The multi-control light regulator of this first embodiment comprises a microprocessor 1, a regulator 2, and a sensor 3.

The microprocessor 1 is electrically connected to a wireless receiver 6 for receiving a control signal from a user and executing the control signal.

The regulator 2 comprises a rectifier 21, and a drive circuit 22 electrically connected with the rectifier 21. The rectifier 21 is a MOSFET (Metal-Oxide Semiconductor Transistor) electrically connected to a power source 4 and an LED lamp 5. The drive circuit 22 is electrically connected to the microprocessor 1.

The sensor 3 is electrically connected to the microprocessor 1 and the power source 4.

Thus, when the wireless receiver 6 receives a control signal from a user, it immediately transmits the control signal to the microprocessor 1. At this time, the microprocessor 1 controls the drive circuit 22 to regulate the voltage of the electricity provided by the power source 4 through the rectifier 21 to the LED lamp 5 subject to the luminosity definition of the control signal, and simultaneous starts up the sensor 3, enabling the sensor 3 to continuously detect the electric current of the power source 4 and to transmit the electric current to the microprocessor 1. If the LED lamp 5 is dimmable, it can be smoothly started up by the voltage provided by the rectifier 21. Because the electric current generated after start up of the LED lamp 5 is kept constant, the LED lamp 5 can be determined to be dimmable if the electric current received by the microprocessor 1 from the sensor 3 is maintained constant. Further, if the LED lamp 5 is not dimmable and the voltage provided by the rectifier 21 is below the rated voltage of the LED lamp 5, the LED lamp 5 cannot be started up by the voltage provided by the rectifier 21 and will produce a visible flickering effect. At this time, the sensor 3 will detect a fluctuating current. Thus, the microprocessor 1 determines the LED lamp 5 as a non-dimmable lamp, and controls the drive circuit 22 to let the electricity of the power source 4 pass through the rectifier 21 to the LED lamp 5 without dropping the voltage. Under this condition, the LED lamp 5 can be normally started up by the rated voltage. Even if the user makes a dimming control to the non-dimmable LED lamp 5, the multi-control light regulator of the present invention can still start up the LED lamp 5 using with the rated voltage, eliminating the technical problem as seen in the prior art designs.

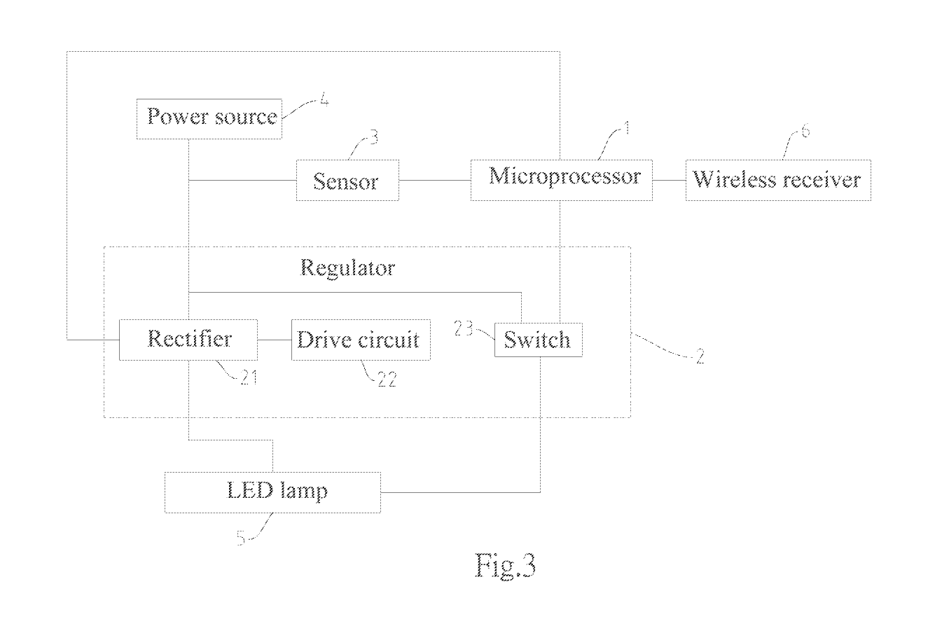

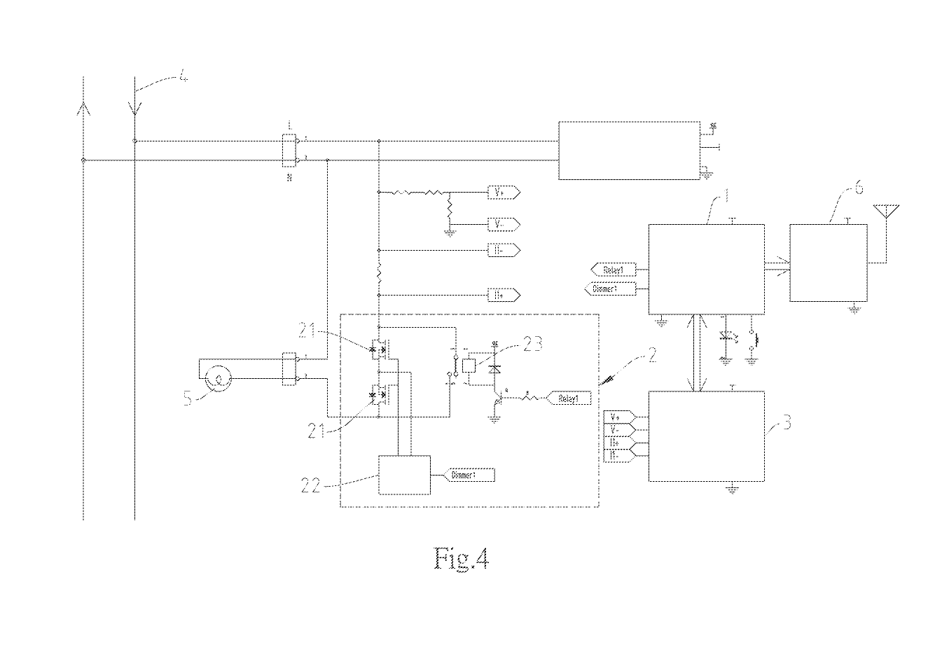

Referring to FIGS. 3 and 4, a multi-control light regulator in accordance with a second embodiment of the present invention is shown. The multi-control light regulator of this second embodiment also comprises a microprocessor 1, a regulator 2, and a sensor 3.

The microprocessor 1 is electrically connected to a wireless receiver 6 for receiving a control signal from a user and executing the control signal.

The regulator 2 comprises a rectifier 21, a drive circuit 22, and a switch 23. The rectifier 21 is a MOSFET (Metal-Oxide Semiconductor Transistor). The switch 23 is a relay. The drive circuit 22 is electrically connected to the rectifier 21. The drive circuit 22 and the switch 23 are electrically connected in parallel to a power source 4 and an LED lamp 5. The drive circuit 22 and the switch 23 are electrically connected to the microprocessor 1.

The sensor 3 is electrically connected to the microprocessor 1 and the power source 4.

As stated above, the differences between this second embodiment and the aforesaid first embodiment are: the regulator 2 further comprises a switch 23 that is electrically connected to the power source 4 and the LED lamp 5 in a parallel manner relative to the rectifier 21. Thus, when the wireless receiver 6 receives a control signal from a user, the microprocessor 1 drives the switch 23 to switch off the circuit, controls the drive circuit 22 to let a corresponding voltage of the power source 4 pass through the rectifier 21 to the LED lamp 5 subject to the luminosity defined by the control signal, and simultaneous starts up the sensor 3, enabling the sensor 3 to continuously detect the electric current of the power source 4 and to transmit the electric current to the microprocessor 1. Similarly, if the LED lamp 5 is dimmable, the LED lamp 5 can be started up by the voltage provided by the rectifier 21. If the LED lamp 5 is not dimmable and the voltage provided by the rectifier 21 is below the rated voltage of the LED lamp 5, the LED lamp 5 will not be started up by the voltage provided by the rectifier 21. At this time, the microprocessor 1 determines the LED lamp 5 to be not dimmable, and controls the drive circuit 22 not to let the electricity of the power source 4 pass through the rectifier 21, i.e., to increase the resistance value of the rectifier 21 and to switch on the switch 23, enabling the electricity of the power source 4 passes through the switch 23 to the LED lamp 5. Thus, the electricity of the power source 4 is provided to the LED lamp 5 without dropping the voltage, enabling the LED lamp 5 be started up with the rated voltage.

What the invention claimed is:

1. A multi-control light regulator, comprising:
a microprocessor;
a regulator comprising a rectifier and a drive circuit, said drive circuit being electrically connected with said rectifier, said rectifier being electrically connected to a power source and an LED lamp, said drive circuit being electrically connected to said microprocessor; and
a sensor electrically connected to said microprocessor and said power source;
wherein said microprocessor controls said drive circuit of said regulator to let said power source pass through said rectifier to said LED lamp, and said sensor continuously detects the electric current of said power source and transmits the electric current to said microprocessor when said power source is passing through said rectifier to said LED lamp; when the value of the electric current received by said microprocessor is constant, said microprocessor keeps the operation status of said drive circuit of said regulator constant; when the value of the electric current received by said microprocessor is changed, said microprocessor controls said drive circuit of said regulator to let said power source fully pass through said rectifier to said LED lamp.

2. The multi-control light regulator as claimed in claim 1, wherein said rectifier of said regulator is a MOSFET (Metal-Oxide-Semiconductor Field-Effect Transistor).

3. The multi-control light regulator as claimed in claim 1, wherein said microprocessor is electrically connected with a wireless receiver for receiving a control signal from a user.

4. A multi-control light regulator, comprising:
a microprocessor;
a regulator comprising a rectifier, a drive circuit and a switch, said drive circuit being electrically connected with said rectifier, said rectifier and said switch being electrically connected in parallel to a power source and an LED lamp, said drive circuit and said switch being respectively electrically connected to said microprocessor; and
a sensor electrically connected to said microprocessor and said power source;
wherein when said microprocessor drives said switch to switch off the circuit and controls said drive circuit of said regulator to let said power source pass through said rectifier to said LED lamp, said sensor continuously detects the electric current of said power source and transmits the electric current to said microprocessor; when the value of the electric current received by said microprocessor is constant, said microprocessor keeps the operation status of said drive circuit and said switch of said regulator constant; when the value of the electric current received by said microprocessor is changed, said microprocessor controls said drive circuit of said regulator to increase the resistance value of said rectifier and said switch to switch on the circuit, letting said power source pass through said rectifier to said LED lamp.

5. The multi-control light regulator as claimed in claim 4, wherein said rectifier of said regulator is a MOSFET (Metal-Oxide-Semiconductor Field-Effect Transistor).

6. The multi-control light regulator as claimed in claim 4, wherein said switch of said regulator is a relay.

7. The multi-control light regulator as claimed in claim 4, wherein said microprocessor is electrically connected with a wireless receiver for receiving a control signal from a user.
